(19) United States
(12) Patent Application Publication
(10) Pub. No.: US 2002/0072898 A1
(43) Pub. Date: Jun. 13, 2002

(54) Audio coding decoding device and method and recording medium with program recorded therein

(76) Inventor: Yuichiro Takamizawa, Tokyo (JP)

Correspondence Address: McGinn & Gibb, PLLC, Suite 200, 8321 Old Courthouse Road, Vienna, VA, 22182-3817, US

(21) Appl. No.: 10/012,411

(22) Filed: Dec. 12, 2001

(30) Foreign Application Priority Data
Dec. 13, 2000 (JP) 378230/2000

(51) Int. Cl. G10L 19/02

(52) U.S. Cl. 704/203

(57) ABSTRACT

An audio coding device for coding input signals of a plurality of channels over a plurality of time sections is disclosed. The device includes a parallel transform unit, which can store input signals of two or more channels and also input signals of two or more time sections in one SIMD variable and collectively perform transform on the input signals of the two or more channels and the input signals of the two or more time sections by using SIMD processor. An audio decoding device includes a parallel in verse transform unit, which can store transformed signals of two or more channels in one SIMD variable and collectively perform inverse transform with respect to the two or more channels by using SIMD processor.

### BACKGROUND OF THE INVENTION

This application claims benefit of Japanese Patent Application No. 2000-378 230 filed on Dec. 13, 2000, the contents of which are incorporated by the reference.

The present invention relates to audio coding and decoding device and method and recording medium with a record of control programs for controlling t he method and, more particularly, to audio coding and decoding device and method permitting reduction of the computational effort of transform and inverse transform and recording medium with control programs for controlling the method recorded therein.

In audio coding, usually an input audio signal in the time domain of each channel is divided into predetermined time sections called “frames”, and the n transformed to a frequency domain signal by such transform as MDCT (Modified Discrete Cosine Transform) or FFT (Fast Fourier Transform), and the transformed signal thus obtained is compressed by quantization or Huffman coding.

In audio decoding, on the other hand, the transformed signal is generated in a process inverse to the coding (such as inverse quantization or Huffman decoding), and the decoded audio signal in the time domain of each channel is obtained for each channel by inverse transform such as IMDCT (Inverse MDCT) or IFFT (Inverse FFT).

As examples of such audio coding and decoding system, an MPEG-2 (Moving Picture Experts Group Phase-2) AAC system and a Dolby AC-3 system are well known. In these systems, MDCT is used as the transform, and IMDCT is used as the inverse transform.

FIG. 4 is a block diagram showing a prior art audio coding device. The illustrated device is for coding a 2-channel (i.e., stereo) audio signal, and it comprises two transform units 401a and 401b and a transformed signal compressing unit 402.

In this prior art audio coding device, one of the two audio signals of the respective channels is inputted to the transform unit 401a, while the other channel audio signal is inputted to the other transform unit 401b. The transform units 401a and 401b transform the audio signals inputted for each channel and each frame and thus obtains transformed signals. The transformed signal compressing unit 402 compresses the transformed signals of two channel by quantization or Huffman coding, and outputs a bit stream thus obtained.

FIG. 5 is a block diagram showing a prior art audio decoding device. The illustrated device is for decoding the two channel audio signals, and it comprises a transformed signal decompressing unit 501 and two inverse transform units 502a and 502b.

The bit stream is inputted to the transformed signal decompressing unit 501. The transformed signal decompressing unit 501 generates the transformed signals of two channel in a process which is inverse to the process in the transformed signal compressing unit (402 in FIG. 4) in the coding device, and outputs one of the transformed signals of the respective channels to the inverse transform unit 502a and the other channel transformed signal to the other inverse transform unit 502b. The inverse transform units 502a and 502b execute inverse transform on the transformed signals inputted for each channel and each frame.

The transform units (401a and 402a in FIG. 4) and inverse transform units (502a and 502b in FIG. 5) usually have to execute many multiplying and arithmetic operations requiring great computational efforts. To realize the audio signal coding and decoding device at a low cost, therefore, it is necessary to reduce the computational efforts in the processing. For realizing reduced computational efforts, many recent microprocessors are provided with SIMD (Single Instruction Stream Multiple Data Stream) variables and SIMD instructions.

An SIMD variable is one which can hold a plurality of values in it. For ex ample, a 64-bit SIMD variable can hold four 16-bit values by dividing its b its into four 16-bit groups from the most significant bit. An SIMD processor is one which can execute multiplying and arithmetic operations with a plurality of SIMD variables.

As an example, an SIMD variable A holding values A1 to A4 and an SIMD variable B holding values B1 to B4 are assumed. By using an SIMD adder in this case for adding together the variables A and B, the operations A1+B1, A2+B2, A3+B3 and A4+B4 can be executed by a single instruction, and the results are stored in an SIMD variable.

Multiplying operations and subtractions are executed likewise. Since the operations on a plurality (i.e., four in this example) values can be execute d with a single instruction, unlike the conventional case of executing operations one by one, it is possible to realize reduced computational effort.

Prior art examples of realizing reduced operational efforts in transform operations using such SIMD variables and SIMD instructions. Intel Inc. shows in “Using MMX Instructions to Implement a Synthesis Sub-Band Filter for MPEGF Audio Decoding”, an example of reducing the computational complexity of inverse transform processing in the MPEG-1 audio system using SIMD variables and SIMD instructions.

A method of utilizing SIMD variables and SIMD instructions shown in an application note of the Intel Inc. In the MPEG-1 audio system, sub-band synthesis filters are used for the inverse transform, and in its processing the following operations called “input butterfly” are executed.

ee(0)=in(0)+in(31)+in(15)+in(16)

ee(1)=in(1)+in(30)+in(14)+in(17)

ee(2)=in(2)+in(29)+in(13)+in(17)

ee(3)=in(3)+in(28)+in(12)+in(19)

In these equations, in(0,. . . , 31) represents input signals for the operations, and ee(0,. . . , 3) represents output signals obtained by the operations.

The operations are executed in the following order.

(1) Four values in(0), in(1), in(2) and in(3) are stored in SIMD variable R0.

(2) Four values in(31), in(30), in(29) and in(28) are stored in SIMD variable R1.

(3) Four values in(15), in(14), in(13) and in(12) are stored in SIMD variable R2.

(4) Four values in(16), in(17), in(18) and in(19) are stored in SIMD variable R3.

(5) SIMD adder executes a calculation R0©R0+R1.

(6) SIMD adder executes a calculation R0©R0+R2.

(7) SIMD adder executes a calculation R0©R0+R3.

In the above way, the values ee(0), ee(1), ee(2) and ee(3) are stored in the SIMD variable R0. The operation results are stored in the SIMD variable again, and the SIMD instruction is repeatedly utilized, thereby realizing the sub-band synthesis processing.

In the above prior art method, the four values stored in a single SIMD variable represent signals of the same channel and the same time section. As an example, two-frame coding of two channel audio signals as shown in FIG. 6 will be described.

(Step 601): Transform of channel 1, frame 2 signal by using SIMD variable and SIMD processor.

(Step 602): Transform of channel 2, frame 1 signal by using SIMD variable and SIMD processor.

(Step 603): Compress transformed signals of the frame 1, channel 1 and 2.

(Step 604): Output bit stream of frame 1.

(Step 605): Transform of channel 1, frame 2 signal by using SIMD variable and SIMD processor.

(Step 606): Transform of channel 1, frame 2 signal by using SIMD variable and SIMD processor.

(Step 607): Compress transformed signals of the frame 2, channel 1 and 2.

(Step 608): output bit stream of frame 2.

In the above prior art system, however, execution of a plurality of commands is sometimes necessary for storing four values in an SIMD variable, requiring a large arithmetic operation. The reason for this is as follows. Usually, four values can be stored in an SIMD variable by a single command so long as they are stored in continuously ascending memory addresses. In many transform and inverse transform processes, however, the four values are not stored in continuously ascending memory addresses. In such cases, a plurality of commands should be executed for changing the storage order. According to the application note of the Intel Inc., seven commands are required for changing the order, thus constituting a cause of increased computational effort.

### SUMMARY OF THE INVENTION

An object of the present invention is to provide a method capable of realizing the transform in the audio coding and the inverse transform in the audio decoding with reduced computational effort.

According to a first aspect of the present invention, there is provided an audio coding device for coding input signals of a plurality of channels over a plurality of time sections including a parallel transform unit, which can store input signals of two or more channels in one SIMD (Single Instruction Stream Multiple Data Stream) variable and collectively perform transform with respect to the two or more channels by using SIMD processor.

According to a second aspect of the present invention, there is provided a n audio coding device for coding input signals over a plurality of time sections including a parallel transform unit, which can store input signals of two or more time sections in one SIMD variable and collectively perform transform with respect to the two or more time sections by using SIMD processor.

According to a third aspect of the present invention, there is provided an audio coding device for coding input signals of a plurality of channels over a plurality of time sections including a parallel transform unit, which can store input signals of two or more channels and also input signals of two or more time sections in one SIMD variable and collectively perform transform on the input signals of the two or more channels and the input signals of the two or more time sections by using SIMD processor.

According to a fourth aspect of the present invention, there is provided a n audio decoding device for decoding input signals of a plurality of channels over a plurality of time sections including a parallel inverse transform unit, which can store transformed signals of two or more channels in one SIMD variable and collectively perform inverse transform with respect to the two or more channels by using SIMD processor.

According to a fifth aspect of the present invention, there is provided an audio decoding device for decoding input signals over a plurality of time sections including a parallel inverse transform unit, which can store input signals of two or more time sections in one SIMD variable and collectively perform inverse transform with respect to the two or more time sections by using SIMD processor.

According to a sixth aspect of the present invention, there is provided an audio decoding device for decoding input signals of a plurality of channel s over a plurality of time sections including a parallel inverse transform unit, which can store input signals of two or more channels and also input signals of two or more time sections in one SIMD variable and collectively perform inverse transform on the input signals of the two o r more channels and the input signals of the two or more time sections by u sing SIMD processor.

According to a seventh aspect of the present invention, there is provided an audio coding method for coding input signals of a plurality of channels over a plurality of time sections including a step for storing input signal s of two or more channels in one SIMD (Single Instruction Stream Multiple Data Stream) variable and a step for collectively performing transform with respect to the two or more channels by using SIMD processor.

According to an eighth aspect of the present invention, there is provided an audio coding method for coding input signals over a plurality of time sections including a step for storing input signals of two or more time sections in one SIMD variable and a step for collectively performing transform with respect to the two or more time sections by using SIMD processor.

According to a ninth aspect of the present invention, there is provided an audio coding method for coding input signals of a plurality of channels over a plurality of time sections including a step for storing input signals of two or more channels and also input signals of two or more time sections in one SIMD variable and a step for collectively performing transform on the input signals of the two or more channels and the input signals of the two or more time sections by using SIMD processor.

According to a tenth aspect of the present invention, there is provided an audio decoding method for decoding input signals of a plurality of channel s over a plurality of time sections including a step for storing signal s of two or more channels in one SIMD variable and a step for collectively performing inverse transform with respect to the two or more channels by using SIMD processor.

According to an eleventh aspect of the present invention, there is provide d an audio decoding method for decoding input signals over a plurality of time sections including a step for storing input signals of two or more time sections in one SIMD variable and a step for collectively performing inverse transform with respect to the two or more time sections by using SIMD processor.

According to a twelfth aspect of the present invention, there is provided an audio decoding method for decoding input signals of a plurality of channels over a plurality of time sections including a step for storing input signals of two or more channels and also input signals of two or more time sections in one SIMD variable and a step for collectively performing inverse transform on the input signals of the two or more channels and the input signals of the two or more time sections by using SIMD processor.

According to a thirteenth aspect of the present invention, there is provided a recording medium storing program for executing with a computer an audio coding processing for coding input signals of a plurality of channels over a plurality of time sections, the program including a step for storing in put signals of two or more channels in one SIMD (Single Instruction Stream Multiple Data Stream) variable and a step for collectively performing transform with respect to the two or more channels by using SIMD process or.

According to a fourteenth aspect of the present invention, there is provided a recording medium storing program for executing with a computer an audio coding processing for coding input signals over a plurality of time sections, the program including a step for storing input signals of two or more time sections in one SIMD variable and a step for collectively performing transform with respect to the two or more time sections by using SIMD processor.

According to a fifteenth aspect of the present invention, there is provide d a recording medium storing program for executing with a computer an audio coding processing for coding input signals of a plurality of channels over a plurality of time sections, the program including a step for storing input signals of two or more channels and also input signals of two or more time sections in one SIMD variable and a step for collectively performing transform on the input signals of the two or more channels and the input signals of the two or more time sections by using SIMD processor.

According to a sixteenth aspect of the present invention, there is provide d a recording medium storing program for executing with a computer an audio decoding processing for decoding input signals of a plurality of channels over a plurality of time sections, the program including a step for storing transformed signals of two or more channels in one SIMD variable and a step for collectively performing inverse transform with respect to the two or more channels by using SIMD processor.

According to a seventeenth aspect of the present invention, there is provided a recording medium storing program for executing with a computer an audio decoding processing for decoding input signals over a plurality of time sections, the program including a step for storing input signals of two or more time sections in one SIMD variable and a step for collectively performing inverse transform with respect to the two or more time sections by using SIMD processor.

According to an eighteenth aspect of the present invention, there is provided a recording medium storing program for executing with a computer an audio decoding processing for decoding input signals of a plurality of channel s over a plurality of time sections, the program including a step for storing input signals of two or more channels and also input signals of two or m ore time sections in one SIMD variable and a step for collectively performing inverse transform on the input signals of the two or more channels and the input signals of the two or more time sections by using SIMD processor.

Other objects and features will be clarified from the following description with reference to attached drawings.

### BRIEF DESCRIPTION OF THE DRAWINGS

FIG. 1 is a block diagram showing an audio coding device according to the present invention;

FIG. 2 is a block diagram showing an audio decoding device according to the p resent invention;

FIG. 3(a) and FIG. 3(b) are a coding procedure and decoding procedure according to the present invention;

FIG. 4 is a block diagram showing a prior art audio coding device;

FIG. 5 is a block diagram showing a prior art audio decoding device; and

FIG. 6 is a flow showing operation processes in the prior art.

### PREFERRED EMBODIMENTS OF THE INVENTION

Preferred embodiments of the present invention will now be described with reference to the drawings.

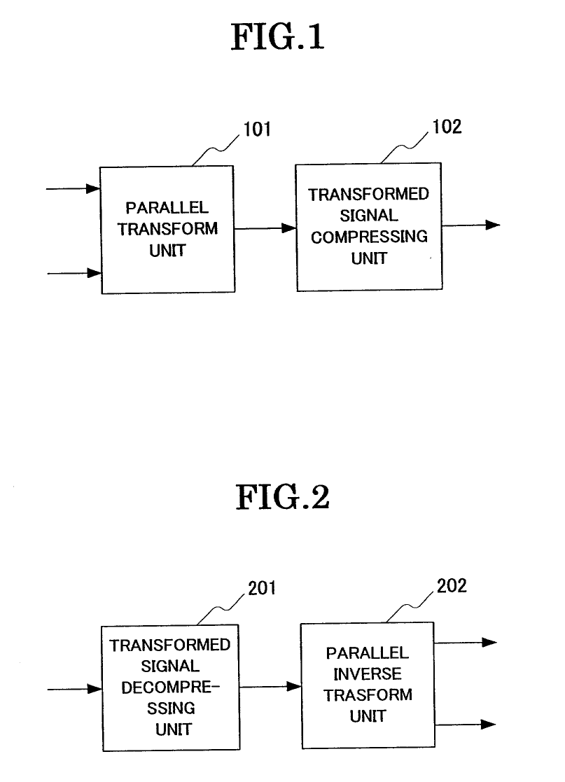

FIG. 1 shows an audio coding device as one embodiment of the present invention. The illustrated audio coding device according to the present invention comprises a parallel transform unit 101 and a transformed signal compressing unit 12.

Two-channel (i.e., stereo) audio signals are inputted to the parallel transform unit 101. The inputted audio signals are subjected to parallel transform using SIMD processors and SIMD variables. The generated transformed signals are outputted to the transformed signal compressing unit 102.

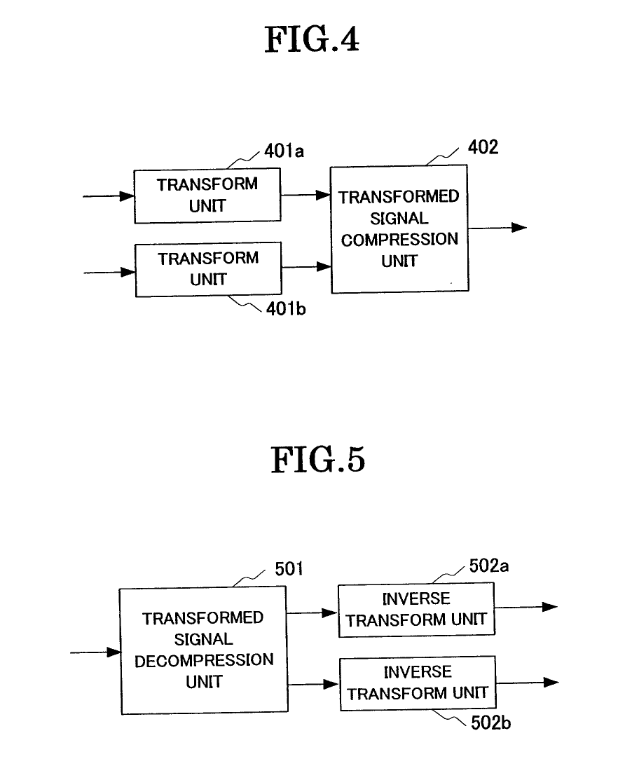

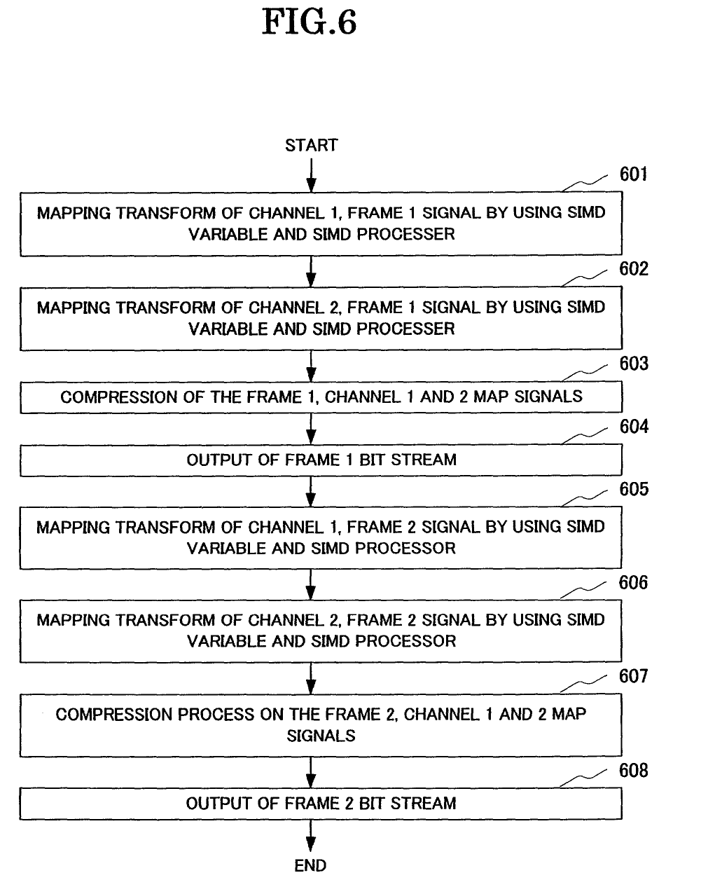

The transformed signal compressing unit 102 compresses the inputted transformed signals in the same manner as in the prior art transformed signal compressing unit (402 in FIG. 4) using such means as quantization or Huffman coding, and outputs the resultant bit stream.

FIG. 2 shows an audio decoding device as one embodiment of the present invention. The illustrated audio decoding device according to the present invention comprises a transformed signal decompressing unit 201 and a parallel inverse transform unit 202.

The transformed signal decompressing unit 201 decompresses the inputted bit stream by using such means as inverse quantization or Huffman decoding in the same manner as in the prior art transformed signal decompressing unit (501 in FIG. 5), and outputs the generated transformed signals to the parallel inverse transform unit 202.

The parallel inverse transform unit 202 executes parallel inverse transform of a plurality of transformed signals by using SIMD processors an d SIMD variables, and outputs the generated decoded audio signals.

The arrangement according to the present invention as described above is different from the prior art technique in that the parallel transform unit (101 in FIG. 1) is provided in lieu of the plurality of transform unit (401a and 401b in FIG. 4) and that the parallel inverse transform unit (202 in FIG. 2) is provided in lieu of the plurality of inverse transform units (502a and 502b in FIG. 5). The remainder of the arrangement is the same as in the prior art and has no direct bearing on the present invention. Besides, the remainder of the arrangement is well known to the person skilled in the art, and it is not described in detail.

The operations of the parallel transform device (101 in FIG. 1) and the parallel inverse transform device (102 in FIG. 2) of the present invention will now be described in detail. Heretofore, the transform process has been performed independently for each channel and each frame. For example, with monaural signals the transform has been performed repeatedly for each frame. With stereo signals, the monaural signal process has been performed repeatedly for several channels. That is, transform processes on different channel or different frame signals have no t been performed at a time.

In contrast, the parallel transform device (101 in FIG. 12) according to the present invention can perform transform processes on different channel and/or different frame signals at a time, thus realizing reduced computational effort. A method of simultaneous input butterfly operations on two different frame signals of two different channels (i.e., a total of four signals) will now be described.

As described before in connection with the prior art, the input butterfly operations are the following calculations.

ee(0)=in(0)+in(31)+in(15)+in(16)

ee(1)=in(1)+in(30)+in(14)+in(17)

ee(2)=in(2)+in(29)+in(13)+in(16)

ee(3)=in(3)+in(28)+in(12)+in(19)

Here, in(0,. . . , 3) represents the input signals in the operations, and ee(0,. . . , 31) represents the output signals obtained in the operations. The simultaneous calculations of these signals of the two different frame (i.e. , frame 1 and frame 2) of the two different channels (i.e., channel 1 and channel 2) will now be described.

(1) Four values of channel 1, frame 1 in(0), channel 2, frame 1 in(0), channel 1, frame 2 in(0) and channel 2, frame 2 in(0) are stored in SIMD variable R0.

(2) Four values of channel 1, frame 1 in(31), channel 2, frame 1 in(31), channel 1, frame 2 in(31) and channel 2, frame 2 in(31) are stored in SIMD variable R1.

(3) Four values of channel 1, frame 1 in(15), channel 2, frame 1 in(15), channel 1, frame 2 in(15) and channel 2, frame 2 in(15) are stored in SIMD variable R2.

(4) Four values of channel 1, frame 1 in(16), channel 2, frame 1 in(16), channel 1, frame 2 in(16) and channel 2, frame 2 in(16) are stored in SIMD variable R3.

(5) SIMD adder executes a calculation R4←R0+R1.

(6) SIMD adder executes a calculation R4←R4+R2.

(7) SIMD adder executes a calculation R4←R4+R3.

(8) Four values of channel 1, frame 1 in(1), channel 2, frame 2 in(1), channel 1, frame 2 in(1) and channel 2, frame 2 in(1) are stored in SIMD variable R0.

(9) Four values of channel 1, frame 1 in(30), channel 2, frame 1 in(30), channel 1, frame 2 in(30) and channel 2, frame 2 in(30) are stored in SIMD variable R1.

(10) Four values of channel 1, frame 1 in(14), channel 2, frame 1 in(14), channel 1, frame 2 in(14) and channel 2, frame 2 in(14) are stored in SIMD variable R2.

(11) Four values of channel 1, frame 1 in(17), channel 2, frame 1 in(17), channel 1, frame 2 in(17) and channel 2, frame 2 in(17) are stored in SIMD variable R3.

(12) SIMD adder executes a calculation R5←R0+R1.

(13) SIMD adder executes a calculation R5←R5+R2.

(14) SIMD adder executes a calculation R5←R5+R3.

(15) Four values of channel 1, frame 1 in(2), channel 2, frame 1 in(21), channel 1, frame 2 in(2) and channel 2, frame 2 in(2) are stored in SIMD variable R0.

(16) Four values of channel 1, frame 1 in(29), channel 2, frame 1 in(29), channel 1, frame 2 in(29) and channel, frame 2 in(29) are stored in SIMD variable R1.

(17) Four values of channel 1, frame 1 in(13), channel 2, frame 1 in(13), channel 1, frame 2 in(13) and channel 2, frame 2 in(13) are stored in SIMD variable R2.

(18) Four values of channel 1, frame 1 in(18), channel 2, frame 1 in(18), channel 1, frame 2 in(18) and channel 2, frame 2 in(18) are stored in SIMD variable R3.

(19) SIMD adder executes a calculation R6←R0+R1.

(20) SIMD adder executes a calculation R6←R6+R2.

(21) SIMD adder executes a calculation R6←R6+R3.

(22) Four values of channel 1, frame 1 in(3), channel 2, frame 1 in(3), channel 1, frame 2 in(3) and channel 2, frame 2 in(3) are stored in SIMD variable R0.

(23) Four values of channel 1, frame 1 in(28), channel 2, frame 1 (28), channel 1, frame 2 in(28) and channel 2, frame 2 in(28) are stored in SIMD variable R1.

(24) Four values of channel 1, frame 1 in(12), channel 2, frame 1 (12), channel 1, frame 2 in(12) and channel 2, frame 2 in(12) are stored in SIMD variable R2.

(25) Four values of channel 1, frame 1 in(19), channel 2, frame 1 in(19), channel 1, frame 2 in(19) and channel 2, frame 2 in(19) are stored in SIMD variable R3.

(26) SIMD adder executes a calculation R7←R0+R1.

(27) SIMD adder executes a calculation R7←R7+R2.

(28) SIMD adder executes a calculation R7←R7+R3.

In the above way, ee(0), ee(1), ee(2) and ee(3) in frame 1 of channel 1, frame 1 of channel 2, frame 2 of channel 2 and frame 2 of channel 2 are stored in SIMD variables R4 to R6. As is seen from the above, by continuously storing the input signals in(n), (n=0,. . . 31), i.e., channel 1, frame 1 in(n), channel 2, frame 1 in(n), channel 1, frame 2 in(n), channel 2, frame 2 in(n), in a memory, the storing order changes in the prior art, which we >re the cause of increasing computational effort, are no longer necessary, and the transform can be realized with low computational effort.

As for in(n) with different values of n, no limitation is imposed on the memory disposition. Thus, operations dealing with signals in(1), in(3), in(5) and in(7), which have heretofore required storing order changes, can be realized without any storing order changes.

While the method of executing parallel input butterfly operations has been described, it will now be described in such general fashion that it can be utilized for other transforms and inverse transforms as well, such as modified discrete cosine transform and inverse modified discrete cosine transform.

When executing operations with variables A and B, heretofore the values of the variables A and B are stored in a memory or a register, and instructions f or performing the operations are executed. According to the present invention, when performing operations with variables A and B with respect to four signals at a time, the conventional process execution program is changed as follows for permitting ready parallel operations.

(1) The program is changed such as to let store variable A of signal 1, variable A of signal 2, variable A of signal 3 and variable A of signal 4 in continuous memory addresses.

(2) The program is changed such as to let store variable B of signal 1, variable B of signal 2, variable B of signal 3 and variable B of signal 4 in continuous memory addresses.

(3) An instruction for reading out variable A is changed to an instruction for reading out variable A of signal 1, variable A of signal 2, variable A of signal 3 and variable A of signal 4 into SIMD variable A′.

(4) An instruction for reading out variable B is changed to an instruction for reading out variable B of signal 1, variable B of signal 2, variable B of signal 3 and variable B of signal 4 into SIMD variable B′.

(5) Instructions for operations with variables A and B are changed to SIMD instructions with respect to SIMD variables A′ and B′.

As shown above, it is one of important feature of the present invention that a plurality of signals which have heretofore been individually subjected to transform processes and inverse transform processes, are stored in the same SIMD variable and processed at a time in SIMD processor. Thus, compared to the prior art SIMD utilization method, no signal storing order change is necessary, thus permitting low computational effort process execution.

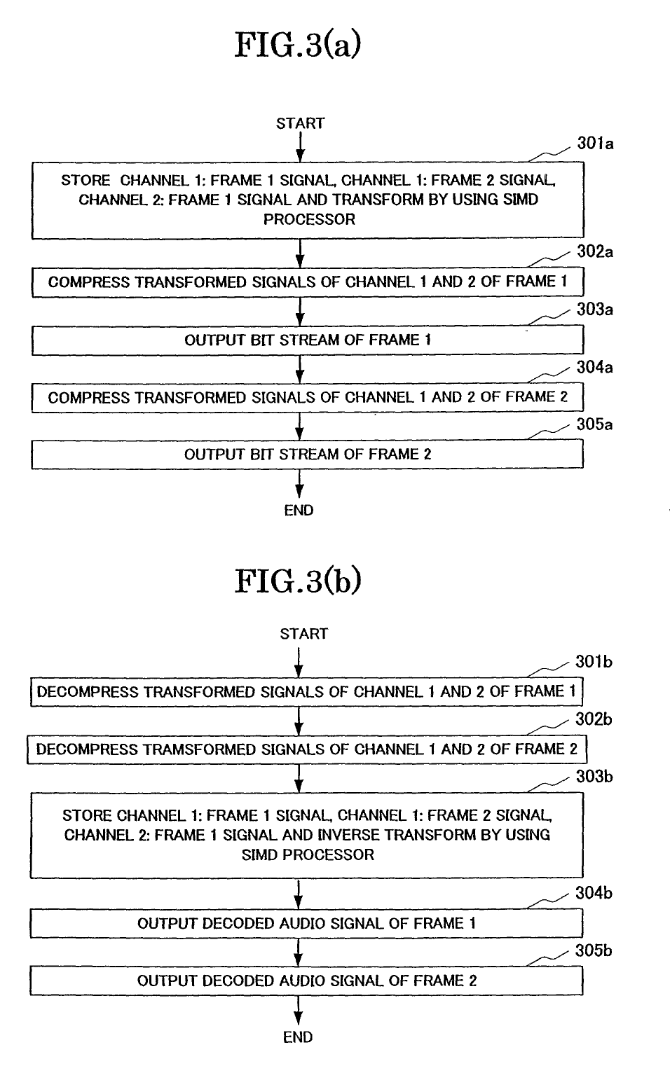

As an example, a process procedure for two frame coding of two channel audio signals will now be described with reference to FIG. 3(a). For three or more frame coding, the procedure is repeatedly executed.

(Step 301a): Channel 1, frame 1 signal, channel 1, frame 2 signal, channel 2, frame 1 signal and channel 2, frame 1 signal are stored in the same SIMD variable, and are subjected to transform by using SIMD processor.

(Step 302a): Transformed signals of channel 1 and 2 of frame 1 are compressed.

(Step 303a): Bit stream of frame 1 is outputted.

(Step 304a) Transformed signals of channel 1 and 2 of frame 2 are compressed.

(Step 305a) Bit stream of frame 2 is outputted.

A process procedure for two frame decoding two channel audio signals will also be described with reference to FIG. 3(b). For three or more frame decoding, the procedure is repeatedly executed.

(Step 301b): Transformed signals of channel 1 and 2 of frame 1 are decompressed.

(Step 302b): Transformed signals of channel 1 and 2 of frame 2 are decompressed.

(Step 303b): Channel 1, frame 1 signal, channel 1, frame 2 signal, channel 2, frame 1 signal and channel 2, frame 2 signal are stored in the same SIMD variable, and are subjected to inverse transform by using SIMD processor.

(Step 304b): Decoded audio signal of frame 1 is outputted.

(Step 305b): Decoded audio signal of frame 2 is outputted.

While the embodiments were concerned with the cases of coding and decoding stereo signals, no limitation is imposed on the number of channels. Also, while the embodiments were concerned with the SIMD variable capable of storing four values, no limitation is imposed on the number of values that can be stored in one SIMD variable.

For example, when performing transform or inverse transform on four channel audio signals or transformed signals, it is possible to realize calculations for the four channels at a time by storing the individual channel signals in one SIMD variable.

Also, when performing transform or inverse transform on one channel audio signal or transformed signal, it is possible to realize calculations for the four time sections at a time by storing the four different frame signals in one SIMD variable.

Furthermore, no limitation is imposed on the combination of the number of channels and the number of frames of the signals stored in one SIMD variable. Moreover, no limitation is imposed on the method of transform and inverse transform; for instance, it is possible to utilize MDCT, IMDCT, FFT and IFFT.

As has been described in the foregoing, according to the present invention it is possible to realized reduced computational efforts in transform and inverse transform. This is so because of the reduced number of instructions necessary for storing values in SIMD variable.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is

1. An audio coding device for coding input signals of a plurality of channels over a plurality of time sections including a parallel transform unit, which can store input signals of two or more channels in one SIMD (Single Instruction Stream Multiple Data Stream) variable and collectively perform transform with respect to the two or more channels by using SIMD processor.

2. An audio coding device for coding input signals over a plurality of time sections including a parallel transform unit, which can store input signals of two or more time sections in one SIMD variable and collectively perform transform with respect to the two or more time sections by using SIMD processor.

3. An audio coding device for coding input signals of a plurality of channels over a plurality of time sections including a parallel transform unit, which can store input signals of two or more channels and also input signals of two or more time sections in one SIMD variable and collectively perform transform on the input signals of the two or more channels and the input signals of the two or more time sections by using SIMD processor.

4. An audio decoding device for decoding input signals of a plurality of channels over a plurality of time sections including a parallel inverse transform unit, which can store transformed signals of two or more channels in one SIMD variable and collectively perform inverse transform with respect to the two or more channels by using SIMD processor.

5. An audio decoding device for decoding input signals over a plurality of time sections including a parallel inverse transform unit, which can store input signals of two or more time sections in one SIMD variable and collectively perform inverse transform with respect to the two or more time sections by using SIMD processor.

6. An audio decoding device for decoding input signals of a plurality of channels over a plurality of time sections including a parallel inverse transform unit, which can store input signals of two or more channels and also input signals of two or more time sections in one SIMD variable and collectively perform inverse transform on the input signals of the two or more channels and the input signals of the two or more time sections by using SIMD processor.

7. An audio coding method for coding input signals of a plurality of channels over a plurality of time sections including a step for storing input signals of two or more channels in one SIMD (Single Instruction Stream Multiple Data Stream) variable and a step for collectively performing transform with respect to the two or more channels by using SIMD processor.

8. An audio coding method for coding input signals over a plurality of time sections including a step for storing input signals of two or more time sections in one SIMD variable and a step for collectively performing transform with respect to the two or more time sections by using SIMD processor.

9. An audio coding method for coding input signals of a plurality of channels over a plurality of time sections including a step for storing input signals of two or more channels and also input signals of two or more time sections in one SIMD variable and s step for collectively performing transform on the input signals of the two or more channels and the input signals of the two or more time sections by using SIMD processor.

10. An audio decoding method for decoding input signals of a plurality of channels over a plurality of time sections including a step for storing transformed signals of two or more channels in one SIMD variable and a step for collectively performing inverse transform with respect to the two or more channels by using SIMD processor.

11. An audio decoding method for decoding input signals over a plurality of time sections including a step for storing input signals of two or more time sections in one SIMD variable and a step for collectively performing in verse transform with respect to the two or more time sections by using SIMD processor.

12. An audio decoding method for decoding input signals of a plurality of channels over a plurality of time sections including a step for storing input signals of two or more channels and also input signals of two or more time sections in one SIMD variable and a step for collectively performing inverse transform on the input signals of the two or more channels and the input signals of the two or more time sections by using SIMD processor.

13. A recording medium storing program for executing with a computer an audio coding processing for coding input signals of a plurality of channels over a plurality of time sections, the program including a step for storing input signals of two or more channels in one SIMD (Single Instruction Stream Multiple Data Stream) variable and a step for collectively performing transform with respect to the two or more channels by using SIMD processor.

14. A recording medium storing program for executing with a computer an audio coding processing for coding input signals over a plurality of time sections, the program including a step for storing input signals of two or more time sections in one SIMD variable and a step for collectively performing transform with respect to the two or more time sections by using SIMD processor.

15. A recording medium storing program for executing with a computer an audio coding processing for coding input signals of a plurality of channels over a plurality of time sections, the program including a step for storing input signals of two or more channels and also input signals of two or more time sections in one SIMD variable and s step for collectively performing transform on the input signals of the two or more channels and the input signals of the two or more time sections by using SIMD processor.

16. A recording medium storing program for executing with a computer an audio decoding processing for decoding input signals of a plurality of channels over a plurality of time sections, the program including a step for storing transformed signals of two or more channels in one SIMD variable and a step for collectively performing inverse transform with respect to the two or more channels by using SIMD processor.

17. A recording medium storing program for executing with a computer an audio decoding processing for decoding input signals over a plurality of time sections, the program including a step for storing input signals of two or more time sections in one SIMD variable and a step for collectively performing inverse transform with respect to the two or more time section s by using SIMD processor.

18. A recording medium storing program for executing with a computer an audio decoding processing for decoding input signals of a plurality of channels over a plurality of time sections, the program including a step for storing input signals of two or more channels and also input signals of two or more time sections in one SIMD variable and a step for collectively performing inverse transform on the input signals of the two or more channels and the input signals of the two or more time sections by using SIMD processor.
